(19) United States
(12) Patent Application Publication
(10) Pub. No.: US 2011/0205172 A1
(43) Pub. Date: Aug. 25, 2011

(54) TOUCH SCREEN DEVICE

(75) Inventor: Takashi KITADA, Fukuoka (JP)

(73) Assignee: PANASONIC CORPORATION, Osaka (JP)

(21) Appl. No.: 13/024,819

(22) Filed: Feb. 10, 2011

(30) Foreign Application Priority Data
Feb. 23, 2010 (JP) 2010-037078

(51) Int. Cl. G06F 3/041

(52) U.S. Cl. 345/173

(57) ABSTRACT

A touch screen device has a panel body that is provided with a plurality of first electrodes arranged parallel with respect to each other, and a plurality of second electrodes arranged parallel with respect to each other, such that the first electrodes and the second electrodes form a grid-shaped pattern. The apparatus also has a controller that detects a touch operation from a side of the panel body based on variations of signals of an endmost electrode, of the first electrodes or of the second electrodes, that is closest to an edge of the panel body and an electrode adjacent to the endmost electrode.

### CROSS-REFERENCE TO RELATED APPLICATIONS

The present application claims priority under 35 U.S.C. §119 of Japanese Application No. 2010-037078, filed on Feb. 23, 2010, the disclosure of which is expressly incorporated by reference herein in its entirety.

### BACKGROUND OF THE INVENTION

1. Field of the Invention

The present invention relates to a touch screen device in which a touch surface is formed on a front of a panel body, and a user performs a touch operation to the touch surface by a pointing object such as the user's finger.

2. Description of Related Art

Usage of a touch screen device has become more widespread in the field of an information apparatus such as a personal computer and a portable information terminal.

In such an information apparatus, the convenience can be improved by enabling an operation on a side of the apparatus separately from a touch operation to the touch surface on the front of the apparatus. For example, in a portable information terminal, an operation unit such as a dial may be provided on a side of the apparatus for selecting icons on a display screen.

However, separately providing such an operating unit causes an increase in the number of components and thereby makes it difficult to downsize the apparatus. It is possible to use flexible materials for members of the panel body, including electrodes, and bend the panel body so that one side of the panel body reaches the front of the apparatus and the other side of the panel body reaches the side of the apparatus. This makes it possible for a user to perform a touch operation on the side of the apparatus, as well as on the touch surface on the front of the apparatus (see Related Art 1).

In the above-described conventional technology, however, there is a likelihood that disconnection of the electrodes, or the like, may happen due to stress caused by bending of the panel body, which causes a result that the reliability of the apparatus will be deteriorated. This situation is not preferable.

Related Art 1: Japanese Patent Application Publication No. 2007-072902

### SUMMARY OF THE INVENTION

The present invention is provided to address such situations and shortcomings of the conventional technology. An objective of the present invention is to provide a touch screen device which enables an operation on a side of an apparatus without separately providing an operating unit and without bending the panel body.

The touch screen device of the present invention has a panel body; and a controller. The panel body is provided with a plurality of first electrodes arranged parallel with respect to each other; and a plurality of second electrodes arranged parallel with respect to each other, such that the first electrodes and the second electrodes form a grid-shaped pattern. The controller detects a touch operation from a side of the panel body based on variations of signals of an endmost electrode, of the first electrodes or of the second electrodes, that is closest to an edge of the panel body and an electrode adjacent to the endmost electrode.

According to the present invention, it is possible to detect a touch operation from the side of the panel body as well as a touch operation on the touch surface on the front of the panel body. An operation can therefore be performed on the side of the apparatus without separately providing an operating unit. Further, it is not necessary to bend the panel body.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a configuration of an entire touch screen device according to the present invention;

FIGS. 2A and 2B are schematic cross-sectional views illustrating the panel body shown in FIG. 1;

FIG. 3 is a perspective view illustrating a portable information terminal to which the touch screen device shown in FIG. 1 is applied;

FIG. 4 illustrates a schematic configuration of the transmitting section and the receiving section shown in FIG. 1;

FIGS. 5A and 5B illustrate an output signal of the transmitting section and an output signal of each section of the receiving section shown in FIG. 1;

FIG. 6A shows a position of a touch operation onto the touch surface shown in FIG. 1 and FIG. 6B illustrates a signal output from an integration section of the receiving section corresponding to the position of the touch operation shown in FIG. 6A;

FIG. 7A shows a position of a touch operation onto the touch surface shown in FIG. 1 and FIG. 7B illustrates a signal output from the integration section of the receiving section corresponding to the position of the touch operation shown in FIG. 7A;

FIG. 8A shows a position of a touch operation onto the touch surface shown in FIG. 1 and FIG. 8B illustrates a signal output from the integration section of the receiving section corresponding to the position of the touch operation shown in FIG. 8A;

FIG. 9A shows a position of a touch operation from a side of the panel body shown in FIG. 1 and FIG. 9B illustrates a signal output from the integration section of the receiving section corresponding to the position of the touch operation shown in FIG. 9A;

FIG. 10A shows a position of a touch operation from a side of the panel body shown in FIG. 1 and FIG. 10B illustrates a signal output from the integration section of the receiving section corresponding to the position of the touch operation shown in FIG. 10A;

FIG. 11A is a cross-sectional view of another embodiment of the panel body shown in FIG. 1 and FIG. 11B is a plan view thereof;

FIG. 12 is a cross-sectional view of another embodiment of the panel body shown in FIG. 1;

FIG. 13 is a cross-sectional view of another embodiment of the panel body shown in FIG. 1;

FIG. 14 is a cross-sectional view of another embodiment of the panel body shown in FIG. 1; and

FIG. 15 illustrates a configuration of another embodiment of the entire touch screen device according to the present invention.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

Hereinafter, embodiments of the present invention will be explained with reference to the drawings.

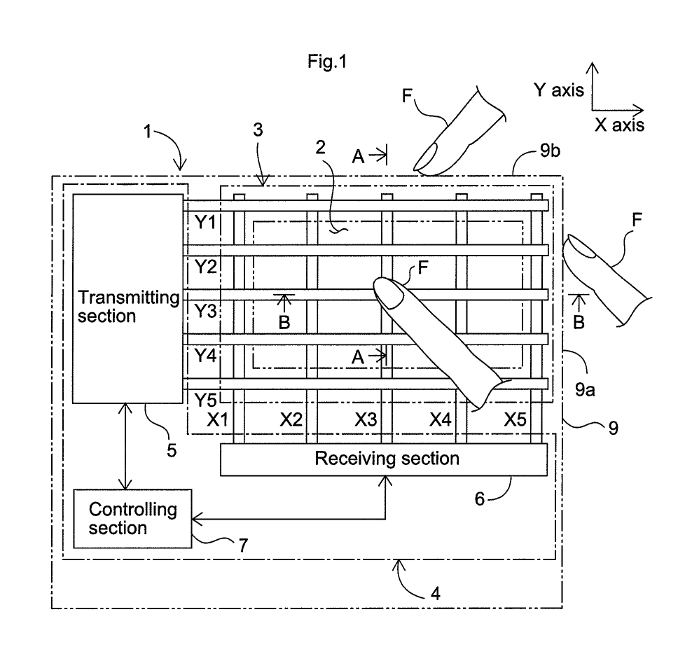

FIG. 1 illustrates a whole configuration of the touch screen device according to the present invention. The touch screen device 1 has a panel body 3 of a flat-plate shape that is provided with a touch surface 2 where a finger F of a user performs a touch operation; and a position detector (controller) 4 that detects a touch position based on variation in capacitance corresponding to a touch operation by a finger F onto the touch surface 2.

In the panel body 3, a plurality of transmitting electrodes (first electrodes) Y1-Y5 are arranged in parallel to each other, and a plurality of receiving electrodes (second electrodes) X1-X5 are arranged in parallel to each other, such that the transmitting electrodes Y1-Y5 and the receiving electrodes X1-X5 form a grid-shaped pattern.

The position detector 4 has a transmitting section (transmitter) 5 that applies a driving signal (pulse signal) to the transmitting electrodes Y1-Y5; a receiving section (receiver) 6 that receives a charge and discharge current signal of the receiving electrodes X1-X5 in response to the driving signal applied to the transmitting electrodes and outputs a level signal per electrode intersection point where the transmitting electrodes Y1-Y5 and the receiving electrodes X1-X5 intersect; and a controlling section (controller) 7 that detects a touch position based on the level signal output from the receiving portion 6 and controls operation of the transmitting section 5 and the receiving section 6.

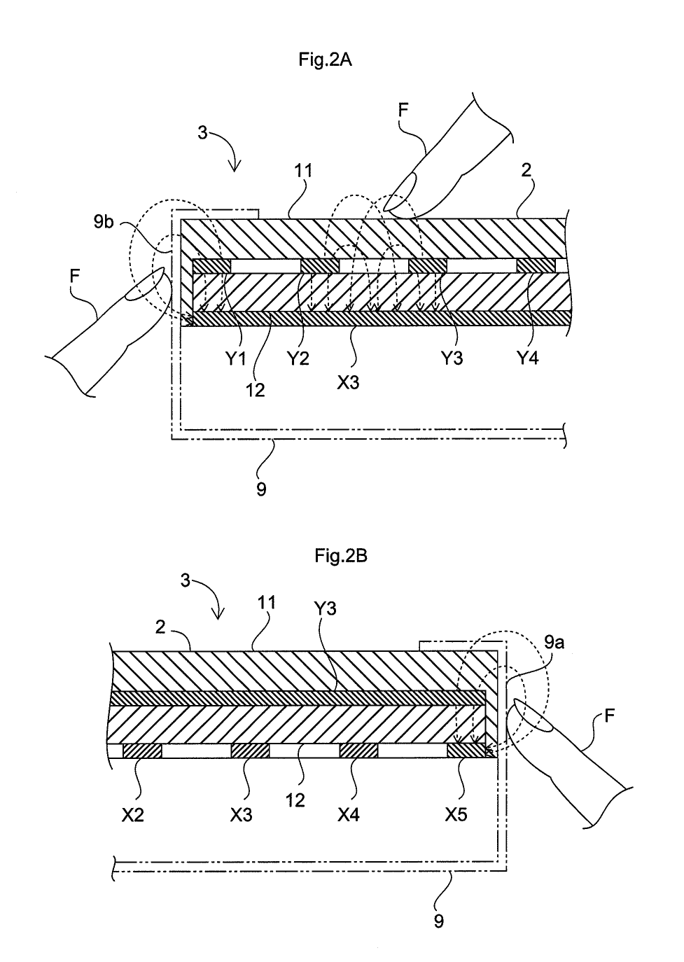

FIGS. 2A and 2B are schematic cross-sectional views illustrating the panel body 3 shown in FIG. 1. FIG. 2A shows a state taken along line A-A in FIG. 1, and FIG. 2B shows a state taken along line B-B. In these drawings, the condition of the electric field is shown by a broken line. Since the panel body 3 can be formed so as to have a thickness of about several mm, the panel body 3 is actually much thinner than a finger F.

The transmitting electrodes Y1-Y5 and the receiving electrodes X1-X5 are protected by a protective insulator 11 on a front surface side, and the surface of the protective insulator 11 having a planar shape serves as the touch surface 2 where a touch operation is performed by a finger F. The transmitting electrodes Y1-Y5 and the receiving electrodes X1-X5 are supported by a supporting sheet 12. The transmitting electrodes Y1-Y5 are provided on a front surface side of the supporting sheet 12, and the receiving electrodes X1-X5 are provided on a rear surface side of the supporting sheet 12. As a non-limiting preferred example, the protective insulator 11 is formed of melamine resin. As for the supporting sheet 12, as a non-limiting example, a film of PET (polyethylene terephthalate) may be used.

Capacitors are formed at electrode intersection points where the transmitting electrodes Y1-Y5 and the receiving electrodes X1-X5 are superposed with the supporting sheet 12 sandwiched therebetween. When a finger F performs a touch operation, capacitance at the electrode intersection point corresponding to the touch operation is substantially reduced, which makes it possible to detect existence or non-existence of the touch operation.

In this embodiment, a mutual capacitance method is employed. According to this method, charge and discharge current is caused to flow through the receiving electrodes X1-X5 in response to application of a driving signal to the transmitting electrodes Y1-Y5, and in this state, when the capacitance in the electrode intersection point is reduced corresponding to a touch operation by a finger F, the charge and discharge current of the receiving electrodes X1-X5 is varied. The variation in the amount of the charge and discharge current is converted to a level signal (digital signal) per electrode intersection point in the receiving section 6, so as to be output to the controlling section 7. The touch position is calculated based on the level signal per electrode intersection point in the controlling section 7. In this mutual capacitance method, it is possible to perform multi-touch detection in which a plurality of touch positions are detected simultaneously.

The controlling section 7 (see FIG. 1) first obtains a level signal per electrode intersection point output from the receiving section 6 in a state where there is no touch operation. When a touch operation is performed thereafter, the level signal is varied corresponding to variation in the capacitance at the electrode intersection point. The controlling section 7 calculates a touch position (coordinate of the center of the touch region) from the varied level signal per electrode intersection point based on predetermined computing processing.

In this computing of the touch position, a touch position is calculated from level signals in a plurality (for example, 4×4) of electrode intersection points adjacent to each other in the X-axis direction (the arrangement direction of the receiving electrodes X1-X5) and the Y-axis direction (the arrangement direction of the transmitting electrodes Y1-Y5), respectively, by using a predetermined interpolation method (for example, centroid method). Accordingly, it is possible to detect a touch position in higher resolution than the arrangement pitch of the transmitting electrodes Y1-Y5 and the receiving electrodes X1-X5.

Here, only a touch operation by a finger F is explained. In the touch screen device 1 of a capacitance method, however, a pointing device that performs a touch operation merely needs to be conductive. It is thus possible to use a stylus made of a conductive material as well as a finger F to perform a touch operation.

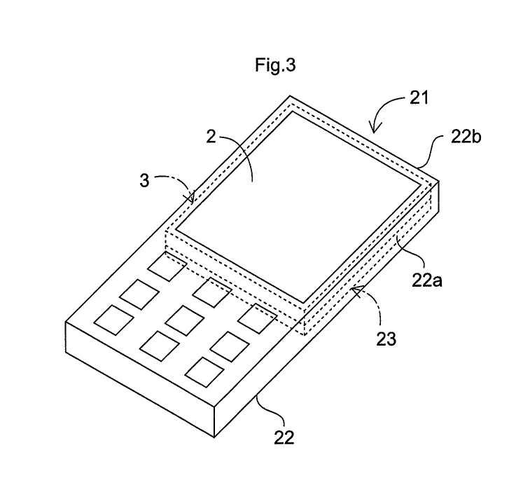

FIG. 3 is a perspective view illustrating a portable information terminal to which the touch screen device 1 shown in FIG. 1 is applied. In the portable information terminal 21, the panel body 3 is accommodated in a case 22 in a state where the touch surface 2 is exposed. A display device 23, such as a liquid crystal display is provided on a rear side of panel body 3. Each member of the panel body 3 is made a transparent material, so that the display screen of the display device 23 can be seen through the panel body 3.

As described below, the touch screen device 1 has a configuration in which a touch operation from a side of the panel body 3 can be detected as well as a touch operation on the touch surface 2. By touching side surfaces 22a and 22b of the case 22, pre-assigned processing is performed. For example, by sliding a finger on the side surface 22a of the case 22, it may be possible to adjust the volume or to switch selection of icons on the display screen.

Incidentally, in order to show the content of processing assigned to a touch operation onto the surfaces 22a and 22b of the case 22, a mark or character may be indicated on the case 22 or displayed on the display screen. Also, a dummy operation unit may be provided on the surfaces 22a and 22b. Further, when a finger contacts the side surfaces 22a and 22b of the case 22 at the time of holding the portable information terminal 21, the contact may be erroneously considered as a touch operation to the side surfaces 22a and 22b of the case 22. Accordingly, for example, it may be arranged that a touch operation to the side surfaces 22a and 22b of the case 22 is effective only when there is another operation such as a touch operation to the touch surface 2. Since this configuration also can eliminate a displacement detector such as a variable-resistance potentiometer that electrically detects displacement of an operating unit, the number of the components can be reduced, and thereby the apparatus can be downsized.

When the touch screen device 1 is configured to be a single body as a coordinate inputting unit, the panel body 3 is accommodated in a case 9 as shown in FIG. 2. The explanation below refers to an example in which a touch operation is performed to side surfaces 9a and 9b of the case 9. In the example where the touch screen device 1 is used in combination with a display device and the like as shown in FIG. 3, however, a touch operation is performed to a case that also accommodates such devices.

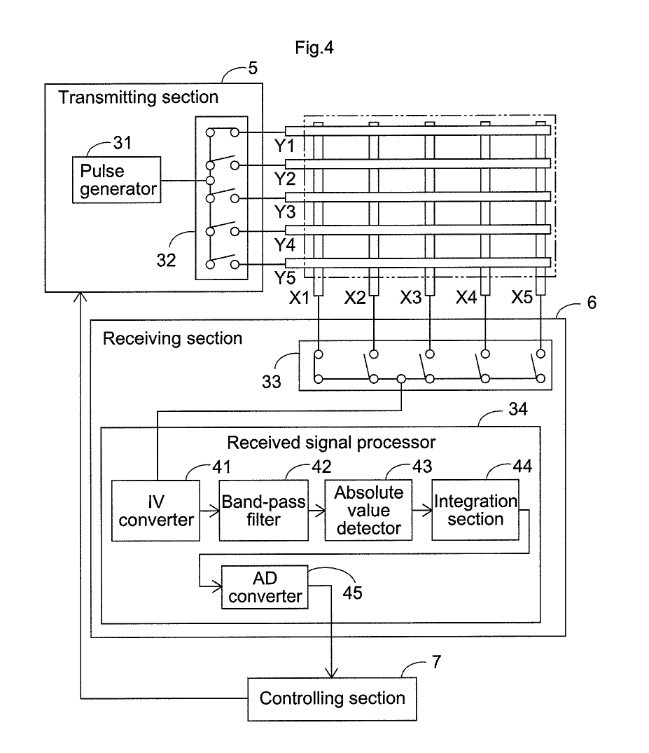

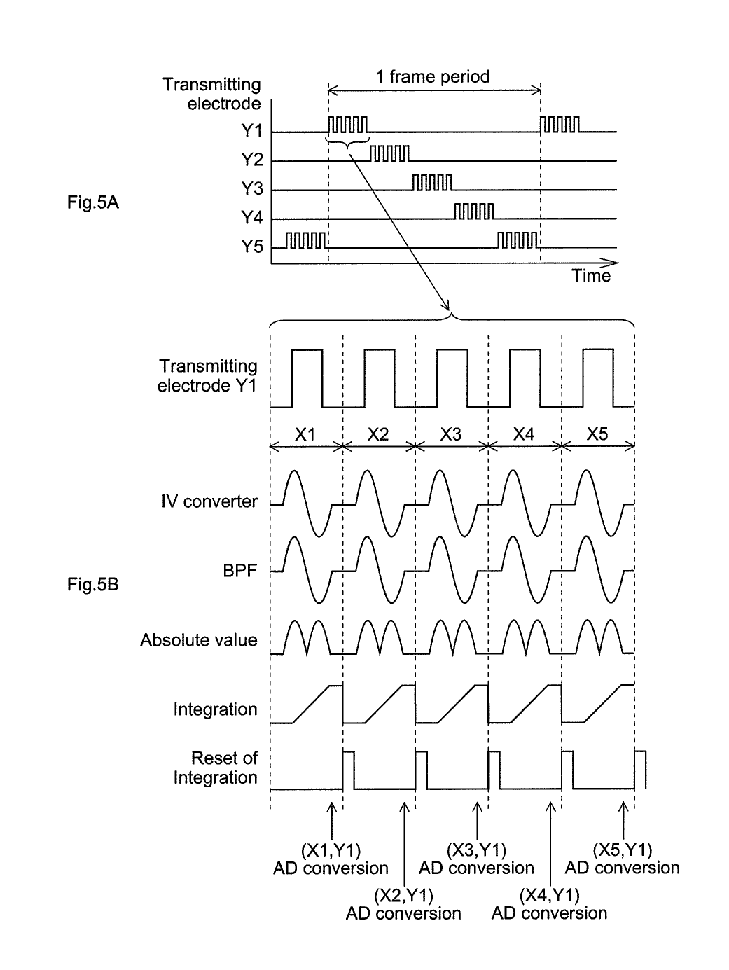

FIG. 4 illustrates a schematic configuration of the transmitting section and the receiving section shown in FIG. 1. FIGS. 5A and 5B illustrate an output signal of the transmitting section 5 and an output signal of each section of the receiving section 6 shown in FIG. 4.

As shown in FIG. 4, the transmitting section 5 has a pulse generator 31 and an electrode selector 32. The pulse generator 31 generates a driving signal (a pulse signal) in synchronization with a timing signal output from the controlling section 7. In the electrode selector 32, switching elements are connected to the transmitting electrodes Y1-Y5, respectively, and driving signals output from the pulse generator 31 are sequentially applied to the transmitting electrodes Y1-Y5 by selecting the transmitting electrodes Y1-Y5 one by one.

As shown in FIG. 4, the receiving section 6 has an electrode selector 33 and a received signal processor 34. In the electrode selector 33, switching elements are connected to the receiving electrodes X1-X5, respectively, and output signals from the receiving electrodes X1-X5 are sequentially input to the processor 34 by selecting the receiving electrodes X1-X5 one by one.

As shown in FIG. 5A, the transmitting section 5 sequentially applies a predetermined number of driving signals (pulse signals) to the transmitting electrodes Y1-Y5 by selecting the transmitting electrodes Y1-Y5 one by one. While the transmitting section 5 applies driving signals to one of the transmitting electrodes Y1-Y5, the receiving section 6 sequentially receives charge and discharge current signals of the receiving electrodes X1-X5 by selecting the receiving electrodes X1-X5 one by one. With this, it is possible to withdraw (i.e., receive) charge and discharge current signals at all of the electrode intersection points.

As shown in FIG. 4, the received signal processor 34 has an IV convertor 41; a band-pass filter 42; an absolute-value detector 43; an integration section 44; and an AD convertor 45.

The IV convertor 41 converts charge and discharge current signals (analog signals) of the receiving electrodes X1-X5, that are input by the electrode selector 33, into voltage signals. The band-pass filter 42 performs processing to the output signals of the IV convertor 41 so as to remove a signal having a component of a frequency other than the frequency of the driving signals applied to the transmitting electrodes Y1-Y5. The absolute-value detector (rectifier) 43 performs full-wave rectification to the signals output from the band-pass filter 42. The integration section 44 performs processing to integrate the signals output from the absolute-value detector 43 in a time-axis direction. The AD convertor 45 performs AD conversion to the output signals of the integration section 44 and outputs level signals (digital signals).

As shown in FIG. 5B, when the driving signals (pulse signals) are applied to the transmitting electrodes Y1-Y5, charge and discharge current flows through the receiving electrodes X1-X5 corresponding to rise and fall of the pulse waves. Corresponding to this, voltage signals output from the IV convertor 41 change with predetermined amplitude. When a touch operation occurs, however, the capacitance at the electrode intersection point is decreased, which causes the amplitude of the voltage signals output from the IV convertor 41 to be decreased and causes the output values of the integration section 44 to be decreased.

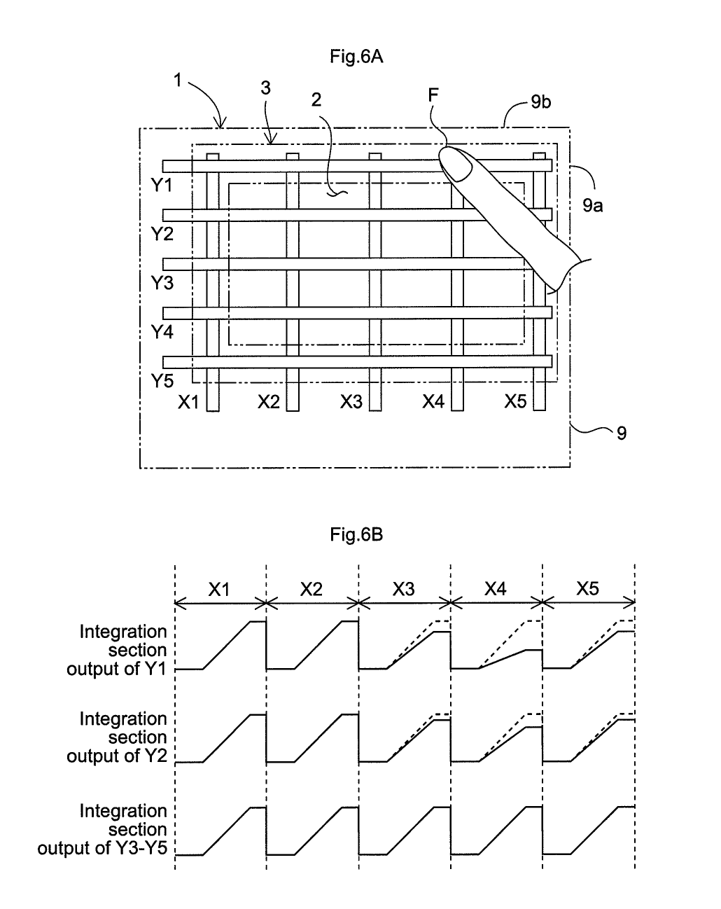

FIGS. 6B, 7B and 8B illustrate a signal output from the integration section 44 of the receiving section 6 corresponding to a position of a touch operation onto the touch surface 2 shown in FIG. 1. In the controlling section 7, a touch position on the touch surface 2 is detected based on the signal output from the receiving electrodes X1-X5 per electrode intersection point by selecting the transmitting electrodes Y1-Y5 and the receiving electrodes X1-X5. Actually, as described above, a touch position is detected based on a digital level signal obtained by performing AD conversion to the output signal of the integration section 44.

FIG. 6A shows a case where a touch is performed onto the electrode intersection point of the transmitting electrode Y1 and the receiving electrode X4 of the touch surface 2. In this case, the capacitance is decreased at the electrode intersection point of the transmitting electrode Y1 and each of the receiving electrodes X3, X4 and X5. Accordingly, as shown in FIG. 6B, the output value of the integration section 44 with respect to the transmitting electrode Y1 and each of the receiving electrodes X3, X4 and X5 is decreased. The degree of the decrease is the greatest in the receiving electrode X4. The degrees of the decrease in the output values of the receiving electrodes X3 and X5, located on both sides of the receiving electrode X4, are smaller than that of the receiving electrode X4. The degrees of the decrease in the output values of the receiving electrodes X3 and X5 are substantially similar. With this, it can be determined that the touch position is on the receiving electrode X4 because the decrease in the output value is the greatest in the receiving electrode X4.

A similar change occurs in the output value of the transmitting electrode Y2 adjacent to the transmitting electrode Y1. However, the degree of the decrease is smaller in the output value of the transmitting electrode Y2 than in the output value of the transmitting electrode Y1. With this, it can be determined that the touch position is at the electrode intersection point of the transmitting electrode Y1 and the receiving electrode X4.

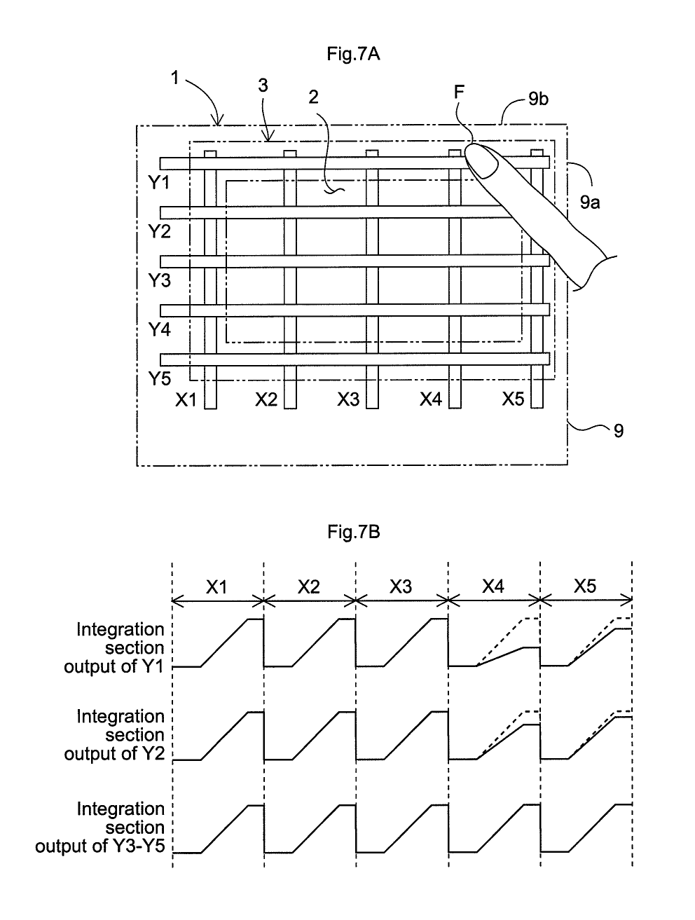

FIG. 7A shows a case where a touch is performed onto the transmitting electrode Y1, and between the receiving electrode X4 and the receiving electrode X5, of the touch surface 2. In this case, the capacitance is decreased at the electrode intersection point of the transmitting electrode Y1 and each of the receiving electrodes X4 and X5. Accordingly, as shown in FIG. 7B, the output value of the integration section 44 with respect to the transmitting electrode Y1 and each of the receiving electrodes X4 and X5 is decreased. In particular, since the degree of the decrease is greater in the output value of the receiving electrode X4 than in the output value of the receiving electrode X5, it can be determined that the touch position is between the receiving electrode X4 and the receiving electrode X5 and closer to the receiving electrode X4.

A similar change occurs in the output value of the transmitting electrode Y2 adjacent to the transmitting electrode Y1. However, the degree of the decrease is smaller in the output value of the transmitting electrode Y2 than in the output value of the transmitting electrode Y1. With this, it can be determined that the touch position is on the transmitting electrode Y1 and between the receiving electrode X4 and the receiving electrode X5.

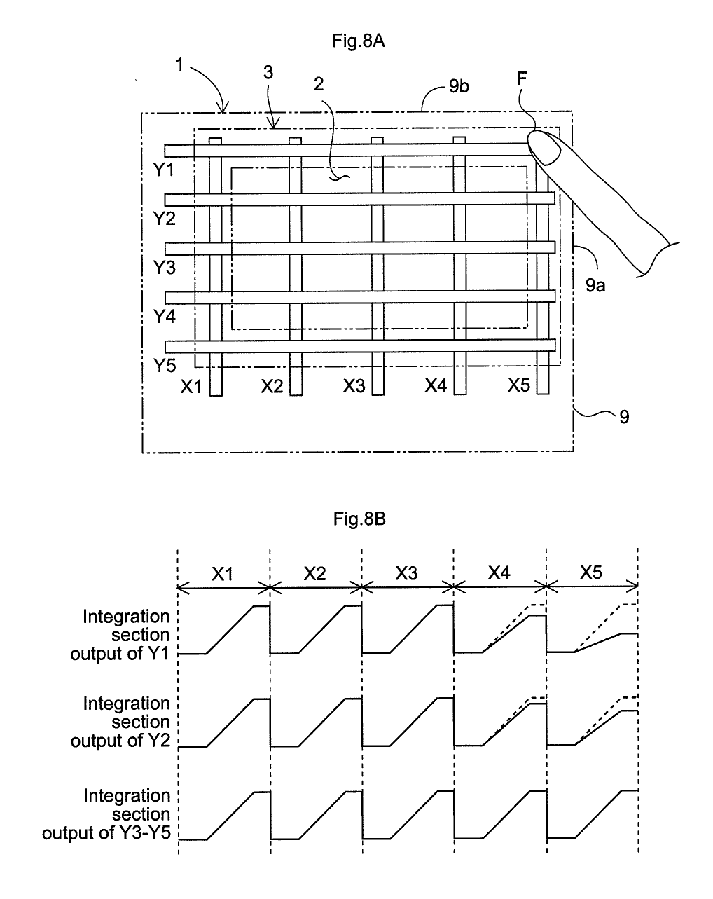

FIG. 8A shows a case where a touch is performed onto the electrode intersection point of the transmitting electrode Y1 and the receiving electrode X5 of the touch surface 2. In this case, the capacitance is decreased at the electrode intersection points of the transmitting electrode Y1 and each of the receiving electrodes X4 and X5. Accordingly, as shown in FIG. 8B, the output value of the integration section 44 with respect to the transmitting electrode Y1 and each of the receiving electrodes X4 and X5 is decreased. The degree of the decrease is great in the output value of the receiving electrode X5, and very small in the output value of the receiving electrode X4. With this, it can be determined that the touch position is on the receiving electrode X5.

A similar change occurs in the output value of the transmitting electrode Y2 adjacent to the transmitting electrode Y1. However, the degree of the decrease is smaller in the output value of the transmitting electrode Y2 than in the output value of the transmitting electrode Y1. With this, it can be determined that the touch position is at the electrode intersection point of the transmitting electrode Y1 and the receiving electrode X5.

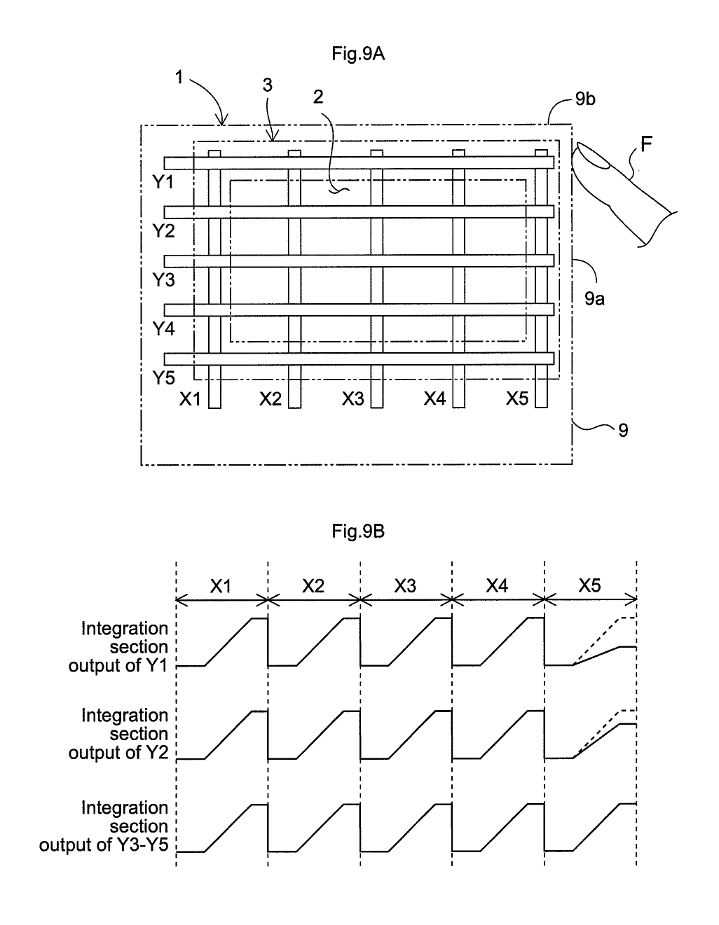

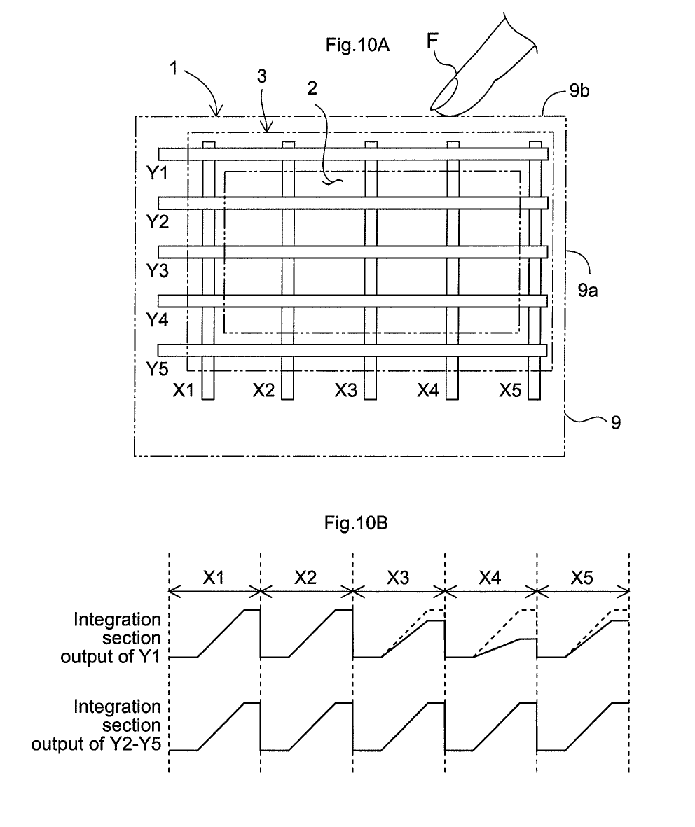

FIGS. 9B and 10B illustrate a signal output from the integration section 44 of the receiving section 6 corresponding to a position of a touch operation on a side of the panel body 3 shown in FIG. 1. The controlling section 7 detects a touch operation from a side of the panel body 3 based on a variation condition of signals of the endmost receiving electrode X5 that is close to the right edge of the panel body 3 and the receiving electrode X4 adjacent thereto, and a variation condition of signals of the endmost transmitting electrode Y1 that is close to the upper edge of the panel body 3 and the transmitting electrode Y2 adjacent thereto.

FIG. 9A shows a case where a touch is performed onto the side of the transmitting electrode Y1 on the side surface 9a of the case 9 extending in a direction along the receiving electrodes X1-X5. In this case, the capacitance is decreased only at the electrode intersection point of the transmitting electrode Y1 and the receiving electrode X5. Accordingly, as shown in FIG. 9B, the output value of the integration section 44 with respect to the transmitting electrode Y1 and the receiving electrode X5 is decreased, and the output value of the integration section 44 with respect to the receiving electrode X4 adjacent to the endmost receiving electrode X5 does not change. With this, it can be determined that the touch position is on the side surface 9a of the case 9, not the touch surface 2.

A similar change occurs in the output value of the transmitting electrode Y2 adjacent to the transmitting electrode Y1. However, the degree of the decrease is smaller in the output value of the transmitting electrode Y2 than in the output value of the transmitting electrode Y1. With this, it can be determined that the touch position is on the side of the transmitting electrode Y1 on the side surface 9a of the case 9.

FIG. 1 OA shows a case where a touch is performed onto the side of the receiving electrode X4 on the side surface 9b of the case 9 extending in a direction along the transmitting electrodes Y1-Y5. In this case, the capacitance is decreased only at the electrode intersection point of the transmitting electrode Y1 and each of the receiving electrodes X3, X4 and X5. Accordingly, as shown in FIG. 10B, the output value of the integration section 44 with respect to the transmitting electrodes Y1 and the receiving electrodes X3, X4 and X5 is decreased, and the output value of the integration section 44 with respect to the transmitting electrode Y2 adjacent to the transmitting electrode Y1 does not change. With this, it can be determined that the touch position is on the side of the receiving electrode X4 on the side surface 9b of the case 9, not the touch surface 2.

Since the touch screen device 1 employs a mutual capacitance method, it is possible to simultaneously detect a touch operation to the side surface 9a of the case 9 as shown in the example of FIG. 9 and a touch operation to the side surface 9b of the case 9 as shown in the example of FIG. 10. It is thus possible to assign processing to a case of simultaneously touching the side surfaces 9a and 9b differently from a case of separately touching the side surfaces 9a and 9b.

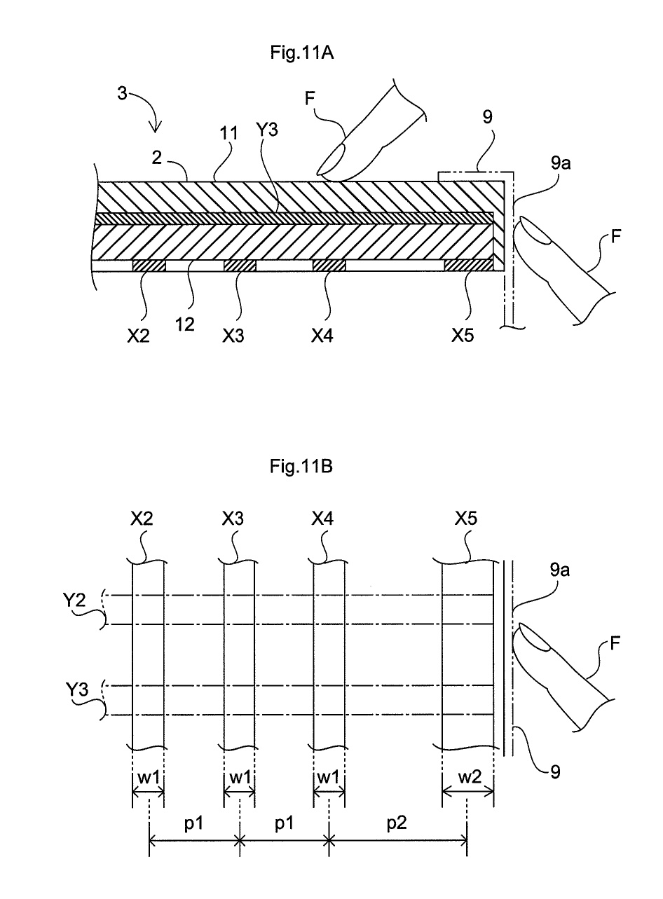

FIG. 11A is a cross-sectional view of another embodiment of the panel body 3 shown in FIG. 1, and FIG. 11B is a plan view illustrating the arrangement status of the receiving electrodes X1-X5. In this embodiment, the endmost receiving electrode X5 is positioned at a greater distance p2 with respect to the receiving electrode X4 adjacent thereto than a distance p1 between the other receiving electrodes X1-X4 (p1<p2). With this, variation in the capacitance corresponding to a touch operation from the side of the panel body 3 is reduced in the receiving electrode X4 adjacent to the endmost receiving electrode X5. Consequently, it is possible to accurately detect a touch operation onto the touch surface 2 and a touch operation from the side of the panel body 3.

The endmost receiving electrode X5 is formed so as to be thicker than the other receiving electrodes X1-X4 (w1<w2). Since this configuration increases variation in charge and discharge current of the endmost receiving electrode X5 corresponding to variation in capacitance in the vicinity of the receiving electrode X5, the detection ability with respect to a touch operation from the side of the panel body 3 is improved. Consequently, it is possible to accurately detect a touch operation on the touch surface 2 and a touch operation on the side of the panel body 3.

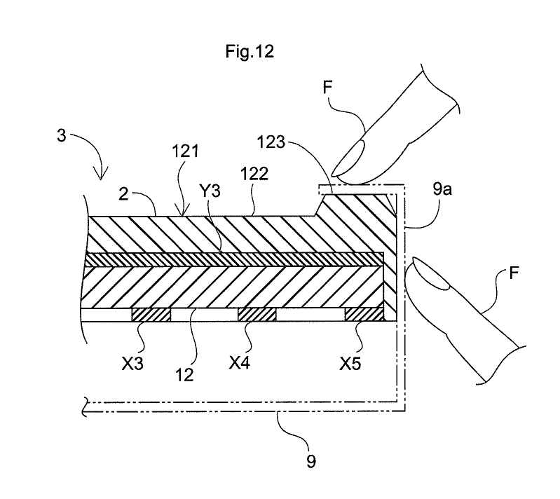

FIG. 12 is a cross-sectional view of another embodiment of the panel body 3 shown in FIG. 1. In this embodiment, a thickened portion 123 is provided in a protective insulator 121 on the front surface side of the endmost receiving electrode X5, such that the thickness of the thickened portion 123 is greater than another surface portion 122 of the touch surface 2.

With this configuration, the distance between a finger F and the endmost receiving electrode X5 increases when the finger F touches from the front surface side of the receiving electrode X5, which decreases variation in capacitance corresponding to a touch operation from the front surface side of the endmost receiving electrode X5, and thereby deteriorates the detection ability with respect to a touch operation from the front surface side of the endmost receiving electrode X5. Consequently, it is possible to determine a touch as a touch operation on the front surface side of the endmost receiving electrode X5 when the degree of the decrease in the output value of the integration section 44 with respect to the receiving electrode X5 is less than a predetermined value, and determine a touch as a touch operation from the side of the receiving electrode X5 when it is equal to or greater than the predetermined value. It is thus possible to prevent a touch operation from the front surface side from being erroneously determined as a touch operation from the side of the panel body 3. Incidentally, the front surface side of the thickened portion 123 may be covered by the case 9 so as to make it out of the range of a touch operation on the touch surface 2.

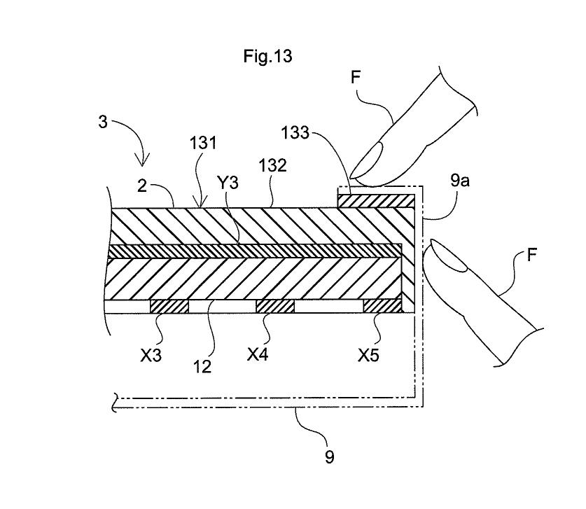

FIG. 13 is a cross-sectional view of another embodiment of the panel body 3 shown in FIG. 1. In this embodiment, a part of a protective insulator 131 on the front surface side of the endmost receiving electrode X5 is covered with a covering portion 133 formed of a material having a low dielectric constant.

With this configuration, similar to the embodiment shown in FIG. 12, variation in capacitance corresponding to a touch operation on the front surface side of the endmost receiving electrode X5 decreases, which results in deterioration of the detection ability with respect to a touch operation on the front surface side of the endmost receiving electrode X5. Consequently, it is possible to determine a touch as a touch operation from the front surface side of the endmost receiving electrode X5 when the output value of the integration section 44 with respect to the receiving electrode X5 is less than a predetermined value, and determine a touch as a touch operation from the side of the receiving electrode X5 when it is equal to or greater than the predetermined value. It is thus possible to prevent a touch operation from the front surface side from being erroneously determined as a touch operation from the side of the panel body 3. As a material having a low dielectric constant to form the covering portion 133, a foam resin material may be used, as a non-limiting example.

A space may be provided between the case and a part of the protective insulator on the front surface side of the endmost receiving electrode X5. This configuration provides an air layer of a low dielectric constant on the front surface side of the endmost receiving electrode X5, and thereby achieves a similar effect. Incidentally, the front surface side of the covering portion 133 or the space may be covered by the case 9 so as to make it out of the range of a touch operation on the touch surface 2.

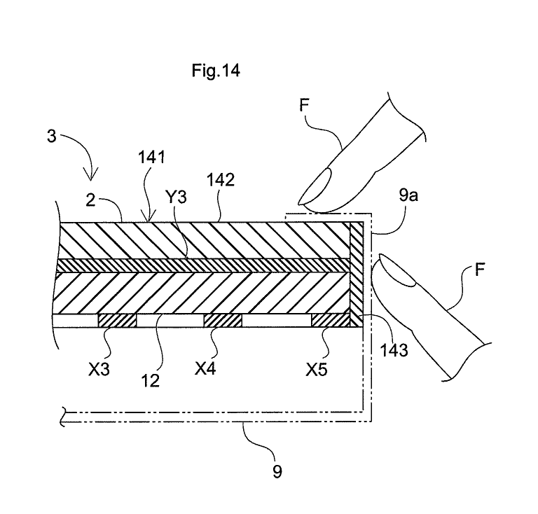

FIG. 14 is a cross-sectional view of another embodiment of the panel body 3 shown in FIG. 1. In this embodiment, a side portion 143 of a protective insulator 141 covering the side surface side of the endmost receiving electrode X5 is formed of a material having a higher dielectric constant than that of the other portion, that is, of a surface portion 142 covering the front surface side of the transmitting electrodes Y1-Y5 and the receiving electrodes X1-X5.

With this configuration, variation in capacitance corresponding to a touch operation from the side of the panel body 3 increases, which results in improvement of the detection ability with respect to a touch operation from the side of the panel body 3. Consequently, it is possible to determine a touch as a touch operation from the front surface side of the endmost receiving electrode X5 when the output value of the integration section 44 with respect to the receiving electrode X5 is less than a predetermined value, and determine a touch as a touch operation from the side of the receiving electrode X5 when it is equal to or greater than the predetermined value. It is thus possible to prevent a touch operation from the front surface side from being erroneously determined as a touch operation from the side of the panel body 3. As a material having a high dielectric constant to form the side portion 143, a glass material or a composite material in which titanium oxide powder is dispersed in resin matrix may be used, as a non-limiting example. Incidentally, the surface portion 142 of the receiving electrode X5 may be covered by the case 9 so as to make it out of the range of a touch operation on the touch surface 2.

FIGS. 11-14 show embodiments regarding the endmost receiving electrode X5 that affects a touch operation to the side surface 9a of the case 9 extending in a direction along the receiving electrodes X1-X5. However, a similar structure can be applied to the endmost transmitting electrode Y1 that affects a touch operation to the side surface 9b of the case 9 extending in a direction along the transmitting electrodes Y1-Y5.

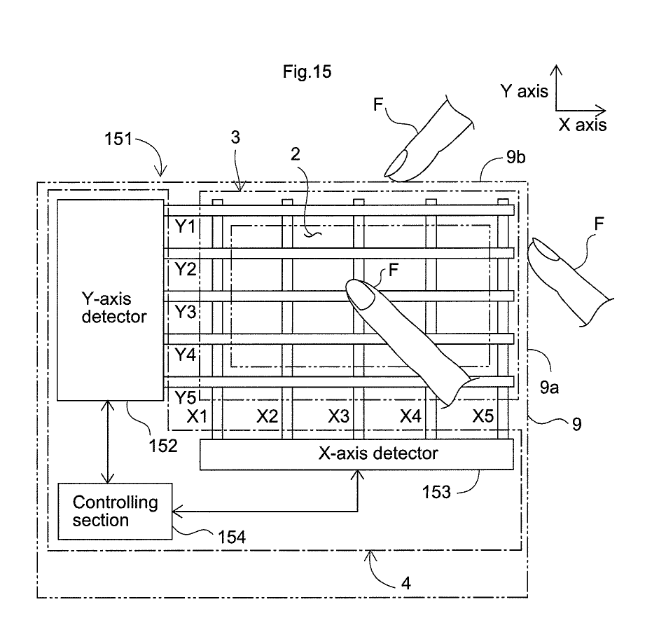

FIG. 15 illustrates an entire configuration of another embodiment of the touch screen device according to the present invention. The structure of the panel body 3 is similar to the example shown in FIG. 1, and the cross-sectional state thereof is similar to the example shown in FIG. 2.

The touch screen device 151 of this embodiment employs a self capacitance method. By sequentially selecting detecting electrodes Y1-Y5 with a Y-axis detector 152, a relaxation oscillator circuit is formed in which the selected one of the electrodes Y1-Y5 is used as a load. A touch position in the Y-axis direction is detected using increase in an oscillation frequency of a signal, that is output from the detecting electrodes Y1-Y5, caused by increase in capacitance corresponding to the touch operation.

An X-axis detector 153 has a similar structure as the Y-axis detector 152. By sequentially selecting detecting electrodes X1-X5 with the X-axis detector 153, a relaxation oscillator circuit is formed in which the selected one of the electrodes X1-X5 is used as a load. A touch position in the X-axis direction is detected using increase in an oscillation frequency of a signal, that is output from the detecting electrodes X1-X5, caused by increase in capacitance corresponding to the touch operation.

A controlling section 154 determines a two-dimensional touch position (coordinate of the center of the touch region) based on a signal frequency or a signal period of each of the detecting electrodes Y1-Y5 and the detecting electrodes X1-X5 output from the Y-axis detector 152 and the X-axis detector 153.

A touch operation to the touch surface 2 changes a signal in a plurality of electrodes among the detecting electrodes X1-X5 in the vicinity of the touch position. In contrast, a touch operation from the side of the panel body 3 changes a signal only in the endmost detecting electrode X5 or the endmost detecting electrode Y1. Based on the change status of a signal, it is possible to distinguish a touch operation to the touch surface 2 from a touch operation on the side of the panel body 3, and further, the touch position on the touch surface 2 or the side of the panel body 3 can be calculated.

The configuration using a mutual capacitance method as shown in FIG. 1 can perform multi-touch detection in which a plurality of touch positions are detected simultaneously. On the other hand, since the configuration using a self capacitance method does not conform to multi-touch detection, it cannot detect a touch operation to the touch surface 2 and a touch operation from the side of the panel body 3 simultaneously.

The touch screen device of the present invention can be configured to be a single body as a coordinate inputting unit or can used in combination with a display device in a personal computer or a portable information terminal. In addition, the touch screen device of the present invention can be used as an interactive whiteboard (electronic blackboard) for a presentation or a lecture directed at a large audience in combination with a large-screen display device.

The touch screen device according to the present invention has an effect that enables an operation in a side surface of the apparatus without separately providing an operating unit in the side surface of the apparatus and without deteriorating the reliability of the apparatus. The touch screen device according to the present invention is useful as a touch screen device, and the like, in which a touch surface is formed in a planar shape on a front surface side of a panel body having a flat-plate shape provided with an electrode and a user performs a touch operation to the touch surface by a pointing device such as the user's finger.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications including combinations of features from various disclosed embodiments may be possible without departing from the scope of the present invention.

What is claimed is:

1. A touch screen device comprising:
a panel body that is provided with a plurality of first electrodes arranged parallel with respect to each other, and a plurality of second electrodes arranged parallel with respect to each other, such that the first electrodes and the second electrodes form a grid-shaped pattern; and
a controller that detects a touch operation from a side of the panel body based on variations of signals of an endmost electrode, of the first electrodes or of the second electrodes, that is closest to an edge of the panel body and an electrode adjacent to the endmost electrode.

2. The touch screen device according to claim 1, wherein the controller detects a touch position based on variation in a charge and discharge current signal, that is output from the second electrodes in response to a driving signal applied to the first electrodes, caused by variation in capacitance corresponding to a touch operation.

3. The touch screen device according to claim 2, wherein the controller detects the touch operation from the side of the panel body when there is a variation of the signal of the endmost electrode and there is no variation of the signal of the electrode adjacent to the endmost electrode.

4. The touch screen device according to claim 1, wherein the endmost electrode and the electrode adjacent to the endmost electrode are positioned at a greater distance than the distances between the other electrodes.

5. The touch screen device according to claim 1, wherein the endmost electrode is thicker than the other electrodes.

6. The touch screen device according to claim 1, wherein the panel body has a front protective insulator on a front of the panel body.

7. The touch screen device according to claim 6, wherein the front protective insulator comprises melamine resin.

8. The touch screen device according to claim 6, wherein a part of the front protective insulator on the front of the endmost electrode is thicker than an other part of the front protective insulator.

9. The touch screen device according to claim 8, wherein the part of the front protective insulator comprises a material of a lower dielectric constant than the other part of the front protective insulator.

10. The touch screen device according to claim 9, wherein the material comprises a foam resin material.

11. The touch screen device according to claim 6, wherein the panel body has a side protective insulator on the side of the panel body.

12. The touch screen device according to claim 11, wherein the side protective insulator comprises a material having a higher dielectric constant than the front protective insulator.

13. The touch screen device according to claim 12, wherein the material comprises a glass material.

14. The touch screen device according to claim 12, wherein the material comprises a composite material.

15. The touch screen device according to claim 14, wherein titanium oxide powder is dispersed in a resin matrix in the composite material.
